(19) United States
(12) Patent Application Publication
(10) Pub. No.: US 2015/0331481 A1
(43) Pub. Date: Nov. 19, 2015

(54) METHOD AND SYSTEM FOR INTERACTION BETWEEN PROJECTOR AND CAMERA

(71) Applicant: Lenovo (Beijing) Co., Ltd., Beijing (CN)

(72) Inventors: Jian YAO, Beijing (CN); Ke CHEN, Beijing (CN); Rongyao FU, Beijing (CN)

(21) Appl. No.: 14/385,400

(22) PCT Filed: Dec. 6, 2013
(86) PCT No.: PCT/CN2013/088766

§ 371 Date: Sep. 15, 2014

(30) Foreign Application Priority Data
Dec. 18, 2012 (CN) 201210552898.4

(51) Int. Cl. G06F 3/01; G03B 17/54

(52) U.S. Cl. CPC G06F 3/011; G03B 17/54

(57) ABSTRACT

A method and system for interaction between a projector and a camera, the method comprising: fixing the positions of a projector and a camera such that the projector and the camera are relatively still, the camera being an infrared camera; determining a first optical axis of the projector and a second optical axis of the camera; allocating a first lens at the intersection of the first optical axis and the second optical axis to process the first optical axis and the second optical axis, such that the first optical axis and the second optical axis are coincident after passing through the first lens.

### CROSS REFERENCE OF RELATED APPLICATION

The application claims priority to Chinese patent application No. 201210552898.4, titled “METHOD AND SYSTEM FOR INTERACTION BETWEEN PROJECTOR AND CAMERA” and filed with the Chinese State Intellectual Property Office on Dec. 18, 2012, which is hereby incorporated by reference in its entirety.

### FIELD

The disclosure relates to the field of an electronic device, and in particular to the technology for interaction between a projector and a camera.

### BACKGROUND

The system for interaction between a projector and a camera is a flexible interacting system. In the system for interacting between the projector and the camera, a body posture obtained by the camera functions as an interacting input and the projection content of the projector functions as an interacting content. For example, in the case that a picture is shown, a projection plane is projected on the wall by the projector, and the picture is displayed on the projection plane; the body posture of a user is obtained by the camera, the picture to be shown is processed (for example, magnifying the picture, switching the picture etc.) based on the obtained body posture, and the processing result is displayed on the projection plane.

The system for interacting between the projector and the camera needs to be adjusted when it is used, and during the adjustment process a dynamic calibration has to be performed based on a distance between the projector and the projection plane. In the conventional technology, the process for calibrating the projector and the camera is relatively complicated.

### SUMMARY

The embodiments of the invention provide a method and a system for interaction between a projector and a camera, which may solve the technical problem that the process for calibrating the projector and the camera is relatively complicated in the conventional technology.

In order to realize the above objects, the embodiments of the invention adopt the following technical solutions.

In an aspect, the embodiments of the invention provide a method for interaction between a projector and a camera, including:

fixing positions of the projector and the camera to make the projector and the camera relatively static, where the camera is an infrared camera;

determining a first optical axis of the projector and a second optical axis of the camera, where the first optical axis is an optical axis of visible light projected from the projector, and the second optical axis is an optical axis of infrared light collected by the camera; and

arranging a first mirror at an intersection of the first optical axis and the second optical axis for processing the first optical axis and the second optical axis to make the first optical axis and the second optical axis which are processed by the first mirror coincidence.

In another aspect, the embodiments of the invention also provide a system for interaction between a projector and a camera, including a projector, a camera and a first mirror, the camera being an infrared camera, where

positions of the projector and the camera are fixed to make the projector and the camera relatively static;

a first optical axis of the projector is determined, where the first optical axis is an optical axis of visible light projected from the projector;

a second optical axis of the camera is determined, where the second optical axis is an optical axis of infrared light collected by the camera; and

the first mirror is arranged at an intersection of the first optical axis and the second optical axis which is configured to process the first optical axis and the second optical axis to make the first optical axis and the second optical axis coincidence after passing through the first mirror.

According to the method and the system for interacting between the projector and the camera provided by the embodiments of the invention, the projector and the camera are fixed, and the first mirror is arranged at the intersection of the first optical axis of the projector and the second optical axis of the camera, therefore the first optical axis and the second optical axis coincide with each other after passing through the first mirror. Compared with the conventional technology, after one time of calibration is completed thus the first optical axis and the second optical axis coincide with each other, no matter how the distance between the projector and the projection plane changes, it is ensured that the projection plane of the projector matches with the photographing plane of the camera without another calibration, therefore the usage of the system for interacting between the projector and the camera is simplified significantly.

### BRIEF DESCRIPTION OF THE DRAWINGS

In order to illustrate the technical solutions in the embodiments of the invention or in the conventional technology more clearly, hereinafter the drawings for the description of the embodiments or the conventional technology will be introduced simply. Obviously, the following described drawings are only some embodiments of the invention, and other drawings may be obtained based on these drawings by those skilled in the art without any creative work.

FIG. 1 is a schematic flow diagram of a method for interaction between a projector and a camera according to a first embodiment of the invention;

FIG. 2 is a schematic flow diagram of a method for interaction between a projector and a camera according to a second embodiment of the invention;

FIG. 3 is a schematic diagram of a system for interaction between a projector and a camera according to the second embodiment of the invention; and

FIG. 4 is a schematic structural diagram of a system for interaction between a projector and a camera according to a third embodiment of the invention.

### DETAILED DESCRIPTION OF THE EMBODIMENTS

The technical solutions of the embodiments of the invention will be described clearly and completely in conjunction with the drawings in the embodiments of the invention hereinafter. Obviously, the described embodiments are only a few embodiments of the invention, not all the embodiments. All of the other embodiments obtained based on the embodiments of the invention by those skilled in the art without any creative work fall within the scope of protection of the disclosure.

### First Embodiment

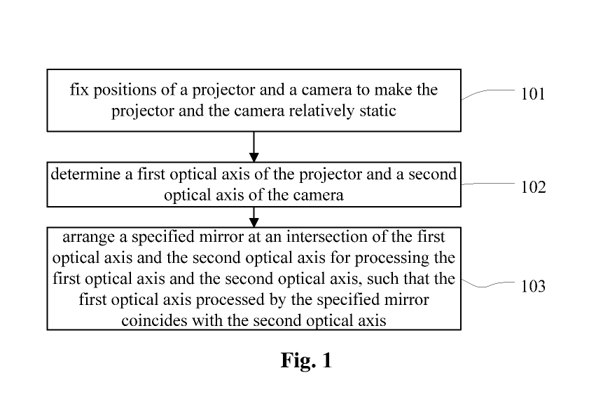

An embodiment of the invention provides a method for interaction between a projector and a camera, as shown in FIG. 1, the method includes step 101 to step 103.

In step 101, positions of the projector and the camera are fixed, therefore the projector and the camera are relatively static, where the camera may be an infrared camera.

In step 102, a first optical axis of the projector and a second optical axis of the camera are determined, where the first optical axis is an optical axis of visible light projected from the projector, and the second optical axis is an optical axis of infrared light collected by the camera.

In step 103, a first mirror is arranged at an intersection of the first optical axis and the second optical axis for processing the first optical axis and the second optical axis to make the first optical axis and the second optical axis which are processed by the first mirror coincidence.

According to the method for interacting between the projector and the camera provided in the embodiment of the invention, the projector and the camera are fixed, and the first mirror is arranged at the interaction of the first optical axis of the projector and the second optical axis of the camera, thus the first optical axis and the second optical axis coincide with each other after passing through the first mirror. Compared with the conventional technology, after one time of calibration is completed, the first optical axis and the second optical axis coincide with each other. No matter how the distance between the projector and the projection plane changes, it is ensured that the projection plane of the projector matches with the photographing plane of the camera without another calibration, therefore the use of the system for interacting between the projector and the camera may be simplified significantly.

### Second Embodiment

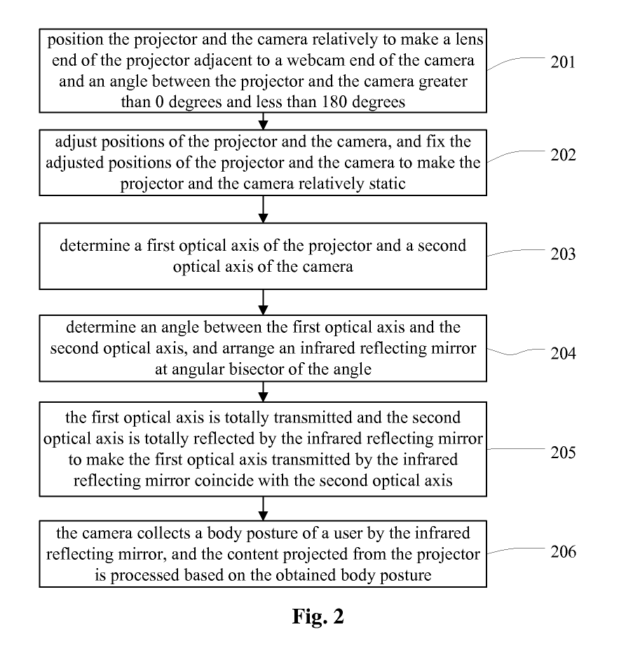

Based on the method shown in FIG. 1, an embodiment of the invention further provides a method for interaction between a projector and a camera, as show in FIG. 2, the method includes step 201 to step 206.

In step 201, the projector and the camera are positioned relatively, thus a lens end of the projector is adjacent to a lens end of the camera and an angle between the projector and the camera is greater than 0 degrees and less than 180 degrees.

The camera in the embodiment may be an infrared camera. In practice, the camera in the embodiment may be a camera of any infrared band.

In step 202, positions of the projector and the camera are adjusted, the adjusted positions of the projector and the camera are fixed, thus the projector and the camera are relatively static.

In the embodiment, when a user uses the system for interacting between the projector and the camera, the positions of the projector and the camera may be adjusted initially, after being adjusted, the positions of the projector and the camera are fixed, and no further adjustment is needed subsequently.

In step 203, a first optical axis of the projector and a second optical axis of the camera are determined.

The first optical axis is an optical axis of visible light projected from the projector, and the second optical axis is an optical axis of infrared light collected by the camera.

The first optical axis in the embodiment is a central axis of a view frustum projected from the projector, and the second optical axis is a central axis of a view frustum collected by the camera.

In step 204, an angle between the first optical axis and the second optical axis is determined, and an infrared reflecting mirror is arranged at an angular bisector of the angle.

The infrared reflecting mirror is the first mirror in the embodiment, which is configured to totally reflect the infrared light and totally transmit the visible light.

In step 205, the first optical axis is totally transmitted and the second optical axis is totally reflected by the infrared reflecting mirror, thus the first optical axis transmitted by the infrared reflecting mirror coincides with the second optical axis.

In order to be understood easily, in the embodiment of the invention, a typical case of the projector being perpendicular to the camera is taken for an example, and a schematic structural diagram of a system for interacting between the projector and the camera is provided. As shown in FIG. 3, the first optical axis of projector 1 is perpendicular to the second optical axis of camera 2, and infrared reflecting mirror 3 is arranged at an angular bisector of an angle between the projector 1 and the camera 2. Visible light 11 projected from the projector 1 is totally transmitted by the infrared reflecting mirror 3, and infrared light 21 is totally reflected by the infrared reflecting mirror 3 and is collected by the camera 2. As shown in FIG. 3, below the infrared reflecting mirror 3, the visible light 11 projected from the projector 1 coincides with the infrared light 21 to be collected by the camera 2, it is ensured that the projection plane of the projector matches with the photographing plane of the camera. Therefore, no matter how the distance between the projector and the projection plane changes, no calibration needs to be performed to the projector and the camera.

In step 206, the camera collects a body posture of a user by the infrared reflecting mirror, and the content projected from the projector is processed based on the obtained body posture.

In practice, the infrared reflecting mirror in step 204 may be an infrared transmitting mirror which is configured to totally transmit the infrared light and totally reflect the visible light. Step 205 may be substituted as that the first optical axis is totally reflected and the second optical axis is totally transmitted by the infrared transmitting mirror, thus the second optical axis transmitted by the infrared transmitting mirror coincides with the first optical axis.

The solution described above is an optional solution. For the optional solution, the difference from step 205 to step 206 lies in that the infrared transmitting mirror functions as the first mirror, the principle is the same as the principle of adopting the infrared reflecting mirror, which is not described here.

A visual angle of the camera may be set to be greater than a visual angle of the projector, thus in a same plane the photographing range of the camera is greater than the projecting range of the projector, thereby ensuring a sufficient large interaction range and facilitating the use for a user.

According to the method for interacting between the projector and the camera provided by the embodiment of the invention, the projector and the camera are fixed, the first mirror is arranged at the intersection of the first optical axis of the projector and the second optical axis of the camera, therefore the first optical axis and the second optical axis coincide with each other after passing through the first mirror. Compared with the conventional technology, after one time of calibration is completed and the first optical axis coincides with the second optical axis, no matter how the distance between the projector and the projection plane changes, it is ensured that the projection plane of the projector matches with the photographing plane of the camera without another calibration, therefore the use of the system for interacting between the projector and the camera may be simplified significantly.

### Third Embodiment

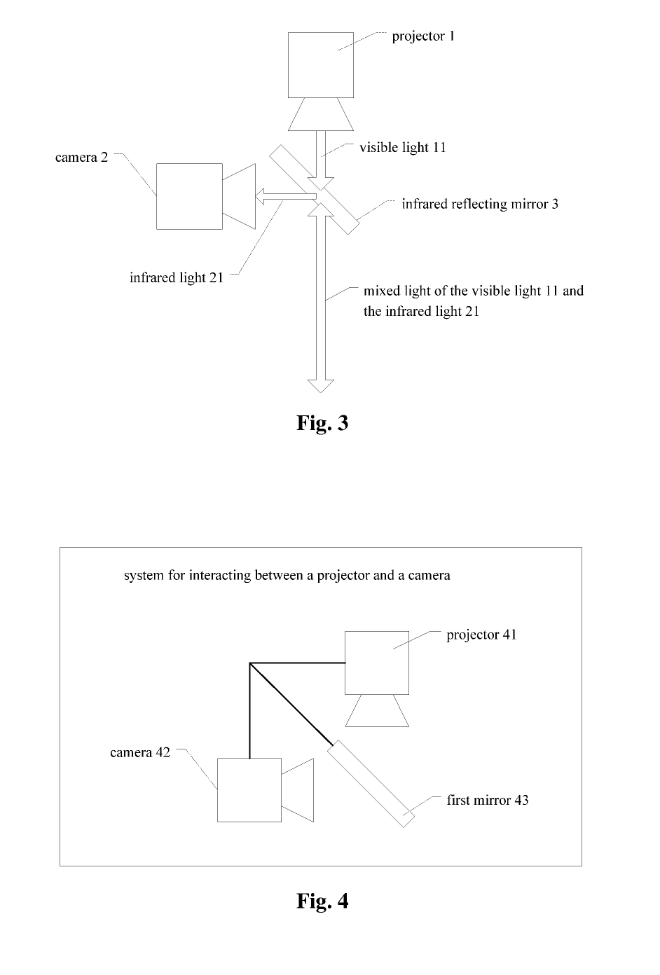

An embodiment of the invention provides a system for interaction between a projector and a camera, which may implement the method embodiments described above. As shown in FIG. 4, the system includes a projector 41, a camera 42 and a first mirror 43, where the camera 42 is an infrared camera.

Positions of the projector 41 and the camera 42 are fixed, thus the projector 41 and the camera 42 are relatively static.

A first optical axis of the projector 41 is determined, where the first optical axis is an optical axis of visible light projected from the projector 41.

A second optical axis of the camera 42 is determined, where the second optical axis is an optical axis of infrared light collected by the camera 42.

The first mirror 43 is arranged at an intersection of the first optical axis and the second optical axis for processing the first optical axis and the second optical axis to make the first optical axis and the second optical axis which are processed by the first mirror coincidence.

The projector 41 and the camera 42 may be positioned relatively, thus a lens end of the projector 41 is adjacent to a lens end of the camera 42 and an angle between the projector 41 and the camera 42 is greater than 0 degrees and less than 180 degrees.

The first mirror 43 may be an infrared reflecting mirror which is configured to totally reflect the infrared light and totally transmit the visible light.

Furthermore, the infrared reflecting mirror is arranged at an angular bisector of an angle between the first optical axis and the second optical axis to totally transmit the first optical axis and totally reflect the second axis, thus the first optical axis transmitted by the infrared reflecting mirror coincides with the second optical axis.

The first mirror 43 may be an infrared transmitting mirror which is configured to totally transmit the infrared light and totally reflect the visible light.

Furthermore, the infrared transmitting mirror is arranged at an angular bisector of the angle between the first optical axis and the second optical axis to totally reflect the first optical axis and totally transmit the second optical axis, thus the second optical axis transmitted by the infrared transmitting mirror coincides with the first optical mirror.

A visual angle of the camera 42 may be set to be greater than a visual angle of the projector 41, thus in a same plane the photographing range of the camera is greater than the projection range of the projector, thereby ensuring a sufficient large interaction range and facilitating the use for a user.

According to the system for interacting between the projector and the camera provided by the embodiment of the invention, the projector and the camera are fixed, the first mirror is arranged at the intersection of the first optical axis of the projector and the second optical axis of the camera, such that the first optical axis and the second optical axis coincide with each other after passing through the first mirror. Compared with the conventional technology, after one time of calibration is completed and the first optical axis and the second optical axis coincide with each other, no matter how the distance between the projector and the projecting plane changes, it is ensured that the projection plane of the projector matches with the photographing plane of the camera without another calibration, therefore the use of the system for interacting between the projector and the camera may be simplified significantly.

Based on the embodiments described above, those skilled in the art may clearly know that the disclosure may be implemented by a combination of software and necessary general hardware, or may be implemented by hardware, however, in many cases the former is the better embodiment. Based on such understanding, the essence part or the part contributing to the conventional technology of the technical solutions of the disclosure may be embodied as a software product; the software product is stored on a readable storage medium such as a soft disc, a hard disc or a compact disc of a computer, and includes several instructions for causing a computer device (for example, a personal computer, a server or a network device) to execute the methods described in various embodiments of the invention.

The above described are only the specific embodiments of the invention, the scope of protection of the disclosure is not limited thereto. Any changes or substitutions which may be easily conceived by those skilled in the art within the technical scope disclosed by the disclosure fall within the scope of protection of the disclosure. Therefore, the scope of protection of the disclosure should be based on the scope of protection defined by the claims.

1. A method for interaction between a projector and a camera, comprising:
fixing positions of the projector and the camera to make the projector and the camera relatively static, wherein the camera is an infrared camera;
determining a first optical axis of the projector and a second optical axis of the camera, wherein the first optical axis is an optical axis of visible light projected from the projector, and the second optical axis is an optical axis of infrared light collected by the camera; and
arranging a first mirror at an intersection of the first optical axis and the second optical axis for processing the first optical axis and the second optical axis to make the first optical axis and the second optical axis coincide with each other by means of the first mirror.

2. The method according to claim 1, wherein fixing positions of the projector and the camera comprises:
positioning the projector and the camera relatively to make a lens end of the projector adjacent to a lens end of the camera and an angle between the projector and the camera greater than 0 degrees and less than 180 degrees.

3. The method according to claim 1, wherein the first mirror is an infrared reflecting mirror which is configured to totally reflect the infrared light and totally transmit the invisible light.

4. The method according to claim 3, wherein arranging a first mirror at an intersection of the first optical axis and the second optical axis for processing the first optical axis and the second optical axis comprises:
determining an angle between the first optical axis and the second optical axis, and arranging the infrared reflecting mirror at an angular bisector of the angle to totally transmit the first optical axis and totally reflect the second optical axis.

5. The method according to claim 1, wherein the first mirror is an infrared transmitting mirror which is configured to totally transmit the infrared light and totally reflect the visible light.

6. The method according to claim 5, wherein arranging a first mirror at an intersection of the first optical axis and the second optical axis for processing the first optical axis and the second optical axis comprises:
determining an angle between the first optical axis and the second optical axis, and arranging the infrared transmitting mirror at an angular bisector of the angle to totally reflect the first optical axis and totally transmit the second optical axis.

7. The method according to claim 1, wherein a visual angle of the camera is greater than a visual angle of the projector.

8. A system for interaction between a projector and a camera, comprising a projector, a camera and a first mirror, the camera being an infrared camera, wherein
positions of the projector and the camera are fixed to make the projector and the camera relatively static;
a first optical axis of the projector is determined, wherein the first optical axis is an optical axis of visible light projected from the projector;
a second optical axis of the camera is determined, wherein the second optical axis is an optical axis of infrared light collected by the camera; and
the first mirror is arranged at an interaction of the first optical axis and the second optical axis, which is configured to process the first optical axis and the second optical axis to make the first optical axis and the second optical axis which are processed by the first mirror coincidence.

9. The system according to claim 8, wherein the projector and the camera are positioned relatively to make a lens end of the projector adjacent to a webcam end of the camera and an angle between the projector and the camera greater than 0 degrees and less than 180 degrees.

10. The system according to claim 8, wherein the first mirror is an infrared reflecting mirror which is configured to totally reflect the infrared light and totally transmit the visible light.

11. The system according to claim 10, wherein the infrared reflecting mirror is arranged at an angular bisector of an angle between the first optical axis and the second optical axis to totally transmit the first optical axis and totally reflect the second axis to make the first optical axis transmitted by the infrared reflecting mirror coincide with the reflected second optical axis.

12. The system according to claim 8, wherein the first mirror is an infrared transmitting mirror which is configured to totally transmit the infrared light and totally reflect the visible light.

13. The system according to claim 12, wherein the infrared transmitting mirror is arranged at an angular bisector of the angle between the first optical axis and the second optical axis to totally reflect the first optical axis and totally transmit the second optical axis to make the second axis transmitted by the infrared transmitting mirror coincide with the reflected first optical axis reflected.

14. The system according to claim 8, wherein a visual angle of the camera is greater than a visual angle of the projector.

15. The method according to claim 2, wherein the first mirror is an infrared reflecting mirror which is configured to totally reflect the infrared light and totally transmit the invisible light.

16. The method according to claim 15, wherein arranging a first mirror at an intersection of the first optical axis and the second optical axis for processing the first optical axis and the second optical axis comprises:
determining an angle between the first optical axis and the second optical axis, and arranging the infrared reflecting mirror at an angular bisector of the angle to totally transmit the first optical axis and totally reflect the second optical axis.

17. The method according to claim 2, wherein the first mirror is an infrared transmitting mirror which is configured to totally transmit the infrared light and totally reflect the visible light.

18. The method according to claim 17, wherein arranging a first mirror at an intersection of the first optical axis and the second optical axis for processing the first optical axis and the second optical axis comprises:
determining an angle between the first optical axis and the second optical axis, and arranging the infrared transmitting mirror at an angular bisector of the angle to totally reflect the first optical axis and totally transmit the second optical axis.

19. The system according to claim 9, wherein the first mirror is an infrared reflecting mirror which is configured to totally reflect the infrared light and totally transmit the visible light.

20. The system according to claim 19, wherein the infrared reflecting mirror is arranged at an angular bisector of an angle between the first optical axis and the second optical axis to totally transmit the first optical axis and totally reflect the second axis to make the first optical axis transmitted by the infrared reflecting mirror coincide with the reflected second optical axis.
